(19) United States
(12) Patent Application Publication
(10) Pub. No.: US 2008/0208632 A1
(43) Pub. Date: Aug. 28, 2008

(54) FREEZING A NETWORK- DELIVERED HEALTHCARE QUESTIONNAIRE

(75) Inventors: James Rosenblum, Chicago, IL (US); Michael Canter, Evanston, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: EMMI Solutions, LLC, Chicago, IL (US)

(21) Appl. No.: 11/830,172

(22) Filed: Jul. 30, 2007

Related U.S. Application Data
(60) Provisional application No. 60/892,185, filed on Feb. 28, 2007.

(51) Int. Cl. G06Q 50/00

(52) U.S. Cl. 705/3

(57) ABSTRACT

A network-delivered healthcare questionnaire may be frozen to prevent misinformation and confusion between a healthcare provider and a patient during a medical course of treatment. A patient accesses the questionnaire regarding an event such as a test or procedure during the patent's course of treatment. The patient submits responses to a plurality of questions. The responses include information that is actionable by the provider and related to the course or treatment. The patient assigns a frozen status to the submitted answers after completing the questionnaire or the provider assigns the frozen status after viewing the submitted responses or another triggering event. Once the responses are frozen, they may not be modified. Any further information the patient wishes to convey to the provider must be submitted directly or through another channel, thus ensuring that both the provider and the patient possess current and accurate information during the course of treatment.

### RELATED DOCUMENTS

The present application claims the benefit of U.S. Provisional Patent Application No. 60/892,185 filed on Feb. 28, 2007, the entire disclosure of which is hereby incorporated by reference.

### FIELD OF THE INVENTION

This patent relates to the field of digital information distribution, and more particularly, to methods for ensuring patient-submitted healthcare information remains accurate and timely during a course of treatment.

### BACKGROUND

Many health care providers maintain patient health records in an electronic database. During a course of treatment, providers must make efficient use of their time with each patient. Electronic health records (EHRs) provide convenient access to patient information both during and after each patient visit. However, because patients' symptoms often change at irregular intervals during the course of treatment and patients frequently schedule provider visits as a reaction to specific, urgent symptoms, a provider may not have complete patient information before an in person meeting. A patient may provide some advance notice of his symptoms by responding to a questionnaire at the provider's office. However, the provider may have little time to adequately or efficiently process the patient's responses before the appointment. The provider may allow the patient to access a web-based questionnaire at some time before the scheduled appointment to allow him more time to understand a patient's symptoms or other characteristics.

Other actions during a course of treatment, for example, medical tests or a surgical procedure, may also benefit from pre-appointment knowledge of symptoms or physical characteristics. For example, before a patient arrives for a procedure requiring anesthesia, questionnaire responses may provide critical information to allow an anesthesiologist to prepare. Before a procedure or test, a patient may provide information relating to any number of characteristics, for example, body weight, age, or gender. However, because the patient characteristics are often manually entered, mistakes may obstruct accurate treatment or testing. While completing the questionnaire, the patient may mistakenly enter a body weight of 185 pounds. The provider, using this mistaken value, may prepare anesthesia for a 185-pound patient. Before the time of the procedure, the patient may realize the error and correct the electronic questionnaire to accurately record a body weight of 285 pounds. The patient may submit this change to the electronic questionnaire under the mistaken belief that the provider will take action on the new or corrected information. However, the anesthesiologist may have too little time to react to the changed information, may not receive the information before commencing the procedure, or may have performed a final review of the patient's information without the patient's knowledge. Therefore, the parties involved in the patient's course of treatment may not be completely informed of changes to an electronic health record or understand that updates or changes to previously-submitted health information may not effectively reach a provider or patient in time for a test, procedure, or appointment. Consequently, improper, incomplete, or inaccurate treatment may occur.

### BRIEF DESCRIPTION OF THE DRAWINGS

FIG. 1 is an exemplary illustration of a computer network;

FIG. 2 is an exemplary illustration of a computing device;

FIG. 3 is an exemplary illustration of a provider and patient network;

FIG. 4 is an exemplary illustration of a block diagram for a method for freezing a patient's health care questionnaire;

FIG. 5 is an exemplary illustration of a notice from a provider to a patient to complete a healthcare questionnaire;

FIG. 6 is an exemplary illustration of a healthcare questionnaire;

FIG. 7a is an exemplary illustration of a notice to a patient after completing and saving a healthcare questionnaire;

FIG. 7b is an exemplary illustration of a notice to a patient after partially completing and saving a healthcare questionnaire;

FIG. 7c is an exemplary illustration of a notice to a patient after at least partially completing a healthcare questionnaire without saving;

FIG. 8 is an exemplary illustration of a healthcare questionnaire after completing the questionnaire;

FIG. 9a is an exemplary illustration of a provider interface for managing patient healthcare questionnaires;

FIG. 9b is an exemplary illustration of a provider interface for displaying information regarding previously-submitted healthcare questionnaires;

FIG. 10a is an exemplary illustration of a provider interface for managing patient healthcare questionnaires;

FIG. 10b is an exemplary illustration of a provider interface for displaying information regarding previously-submitted healthcare questionnaires; and

FIG. 11 is an exemplary illustration of a healthcare questionnaire after a provider freezes the questionnaire.

### DETAILED DESCRIPTION OF THE INVENTION

Much of the inventive functionality and many of the inventive principles described below are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

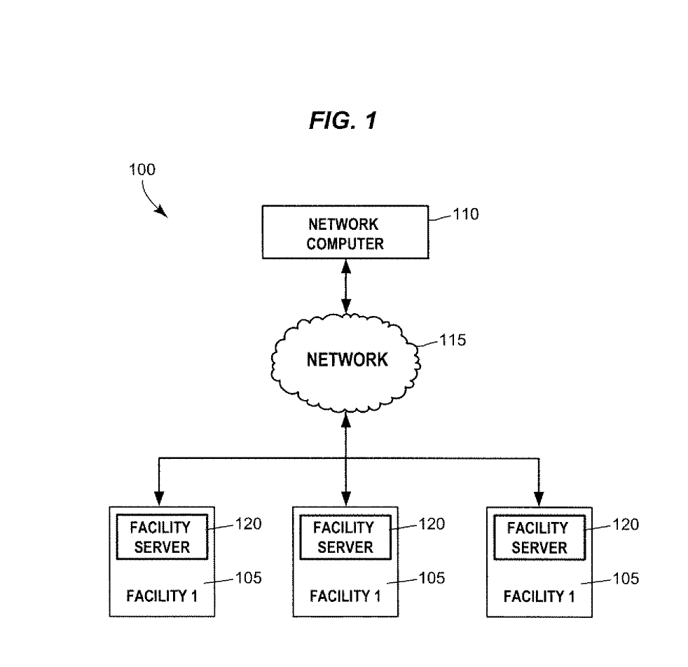

FIG. 1 illustrates an embodiment of a data network 100 including a first group of health care provider facilities 105 operatively coupled to a network computer 110 via a network 115. The plurality of provider facilities 105 may be located, by way of example rather than limitation, in separate geographic locations from each other, in different areas of the same city, or in different states. The network 115 may be provided using a wide variety of techniques well known to those skilled in the art for the transfer of electronic data. For example, the network 115 may comprise dedicated access lines, telephone lines, satellite links, combinations of these, etc. Additionally, the network 115 may include a plurality of network computers 110 or server computers (not shown), each of which may be operatively interconnected in a known manner. Where the network 115 comprises the Internet, data communication may take place over the network 115 via an Internet communication protocol.

The network computer 110 may be a server computer of the type commonly employed in networking solutions. The network computer 110 may be used to accumulate, analyze, and download health care provider 305 data. For example, the network computer 110 may periodically receive data from each of the provider facilities 105 indicative of information pertaining to a patient 310 health record, provider 305 recommended course of action, current test results, historic test results, etc. The network computer 110 may also be a personal computer at which a patient 310 may access and view information served from other network computers 110 or servers 120 at the provider facilities 105. For example, the provider facilities 105 may include one or more facility servers 120 that may be utilized to store information for a plurality of patients.

Although the data network 100 is shown to include one network computer 110 and three provider facilities 105, it should be understood that different numbers of computers and providers may be utilized. For example, the data network 100 may include a plurality of network computers 110 and dozens of provider facilities 105, all of which may be interconnected via the network 115. According to the disclosed example, this configuration may provide several advantages, such as, for example, enabling near real time uploads and downloads of information as well as periodic uploads and downloads of information. This communication may allow a primary backup of all the information generated in the process of updating and accumulating provider 305 and patient 310 data.

The network computer 110 may be connected to a network 115, including local area networks (LANs), wide area networks (WANs), portions of the Internet such as a private Internet, a secure Internet, a value-added network, or a virtual private network. Suitable network computer 110 may also include personal computers, laptops, workstations, mainframes, information appliances, personal digital assistants, and other handheld and/or embedded processing systems. The signal lines that support communications links to a network computer 110 may include twisted pair, coaxial, or optical fiber cables, telephone lines, satellites, microwave relays, modulated AC power lines, and other data transmission “wires” known to those of skill in the art. Further, signals may be transferred wirelessly through a wireless network or wireless LAN (WLAN) using any suitable wireless transmission protocol, such as the IEEE series of 802.11 standards. Although particular individual and network computer systems and components are shown, those of skill in the art will appreciate that the present invention also works with a variety of other networks and computers.

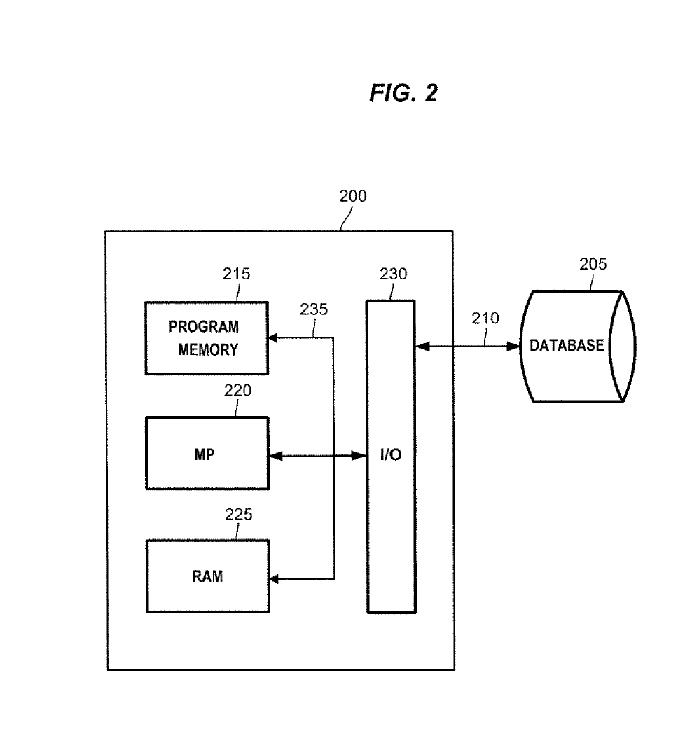

FIG. 2 is a schematic diagram of one possible embodiment of the network computer 110 shown in FIG. 1. The network computer 110 may have a controller 200 that is operatively connected to a database 205 via a link 210. It should be noted that, while not shown, additional databases may be linked to the controller 200 in a known manner.

The controller 200 may include a program memory 215, a microcontroller or a microprocessor (MP) 220, a random-access memory (RAM) 225, and an input/output (I/O) circuit 230, all of which may be interconnected via an address/data bus 235. It should be appreciated that although only one microprocessor 220 is shown, the controller 200 may include multiple microprocessors 220. Similarly, the memory of the controller 200 may include multiple RAMs 225 and multiple program memories 215. Although the I/O circuit 230 is shown as a single block, it should be appreciated that the I/O circuit 230 may include a number of different types of I/O circuits. The RAM(s) 225 and program memories 215 may be implemented as semiconductor memories, magnetically readable memories, and/or optically readable memories, for example.

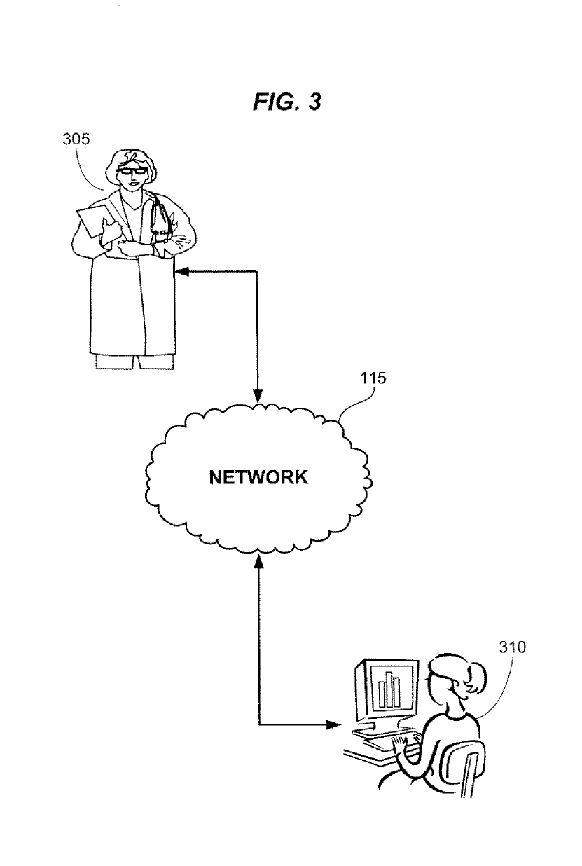

FIG. 3 is one example of a computer network 115 over which a doctor or provider 305 and a patient 310 may communicate using a network computer 110, provider facility server 120, or another mode of communication. In one embodiment, a patient 310 may respond to an electronically-delivered healthcare questionnaire 605 at a network computer 110. Further, the questionnaire 605 responses may be delivered to a network computer 110 that may be accessed by a provider 305. The network computers 110 or servers 120 may implement a method 400, as described below, to ensure that all healthcare information submitted by the patient 310 or the provider 305 is accurate and timely during a course of treatment.

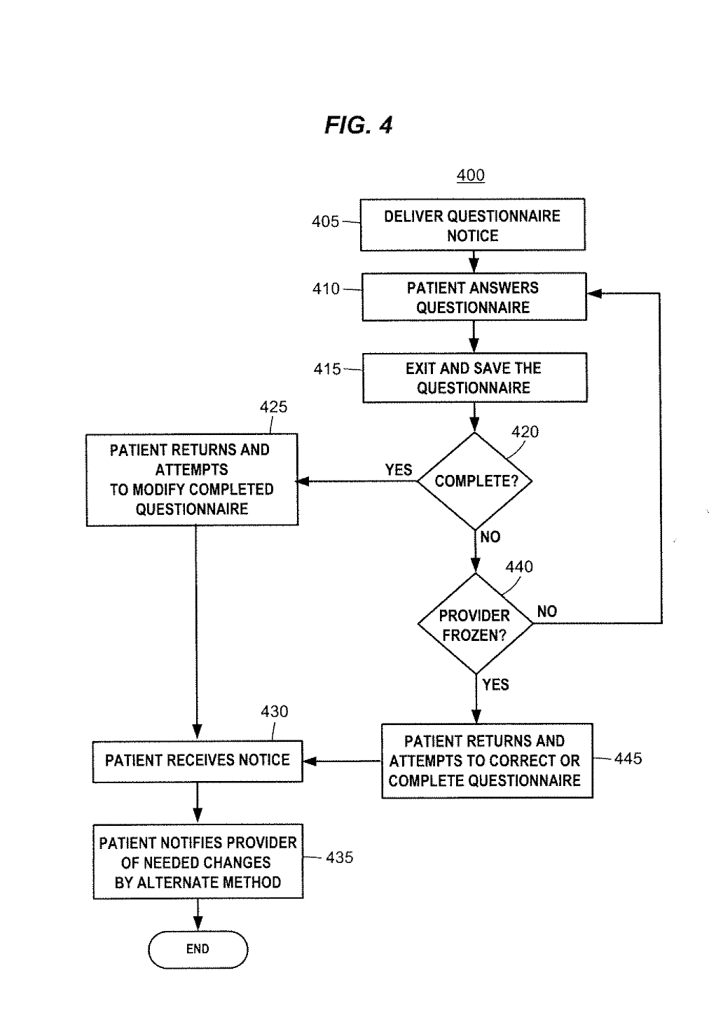

The methods illustrated in the figures and described below may be implemented on a variety of wired and wireless networks and connections. Further, any action associated with the blocks described below and illustrated in FIG. 4 may be performed in any order, or at any time during the method 400 execution. With reference to the Figures, a method 400 for freezing a patient's 310 submitted questions to a healthcare questionnaire 605 may be described.

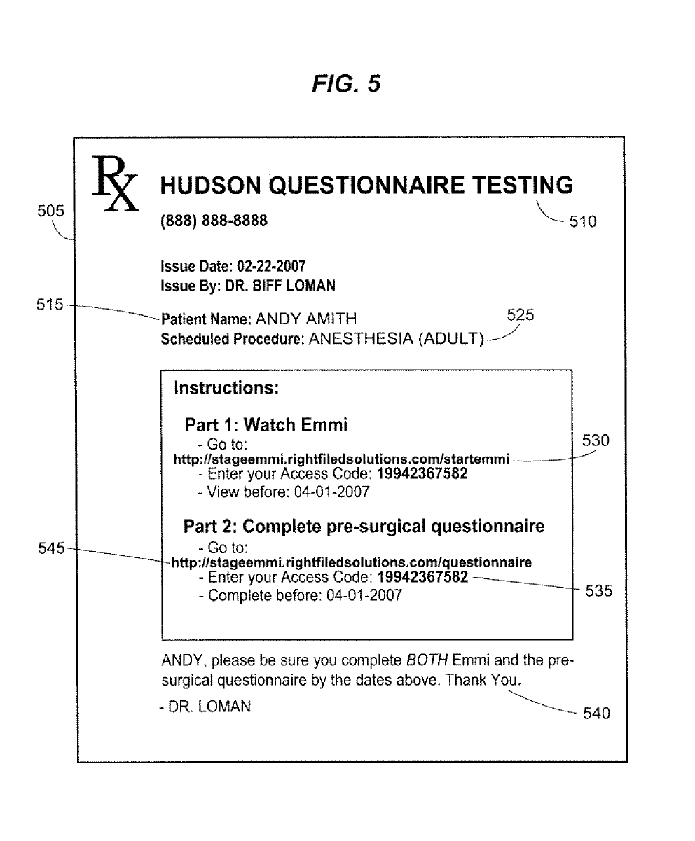

With reference to FIGS. 3, 4, and 5, at block 405, a patient 310 may receive a notice 505 that a healthcare questionnaire 605 is available for completion. The notice 505 may be a ‘prescription’ given directly from the provider 305 to the patient 310, a letter delivered by mail, an e-mail message, a facsimile, an audio message delivered by telephone, or any other form of communication from the provider 305 to the patient 310. The notice 505 may also include a questionnaire origin 510, a patient name 520, a scheduled procedure 525, a website hyperlink 545 and/or an access code for healthcare education information 530, an access code for an electronic pre-surgical or pre-appointment questionnaire 535, and a comment 540 from the provider 305 to patient 310. Of course, the notice 505 may contain many other pieces of relevant and useful information.

With reference to FIGS. 1, 3, 5, and 6, at block 410, a patient 310 may access and answer an electronic questionnaire 605 using information provided in the notice 505. In one embodiment, the patient 310 may access the questionnaire 605 by selecting a hyperlink 545 that directs a browser executing on a patient's 310 network computer 110 to a website server 120 at a provider facility 105. In another embodiment, the patient 310 may receive the questionnaire 605 in paper form, as an automated telephone service, or any other form that may be communicated from the provider 305 to the patient 310. The questionnaire 605 may solicit any information from the patient 310 that may be relevant to the patient's 310 healthcare. In one embodiment, the questionnaire 605 may be tailored to a specific test, procedure, examination, or other course of treatment action. In a further embodiment, the questionnaire 605 may be general in scope and encompass a variety of healthcare applications. For example, the questionnaire 605 may include an origin 610 and purpose 615 for the questionnaire 605 along with a procedure name 620, a patient's general physical characteristics 625, specific questions related to the procedure 630, and a comments or questions area 635. Other embodiments may include any number of questions and include several comments and questions areas. Additionally, the questionnaire 605 may include a number of status assignment buttons 640. In one embodiment, the status assignment buttons 640 include a save and finish later button 645, a finish button 650, and an exit button 655.

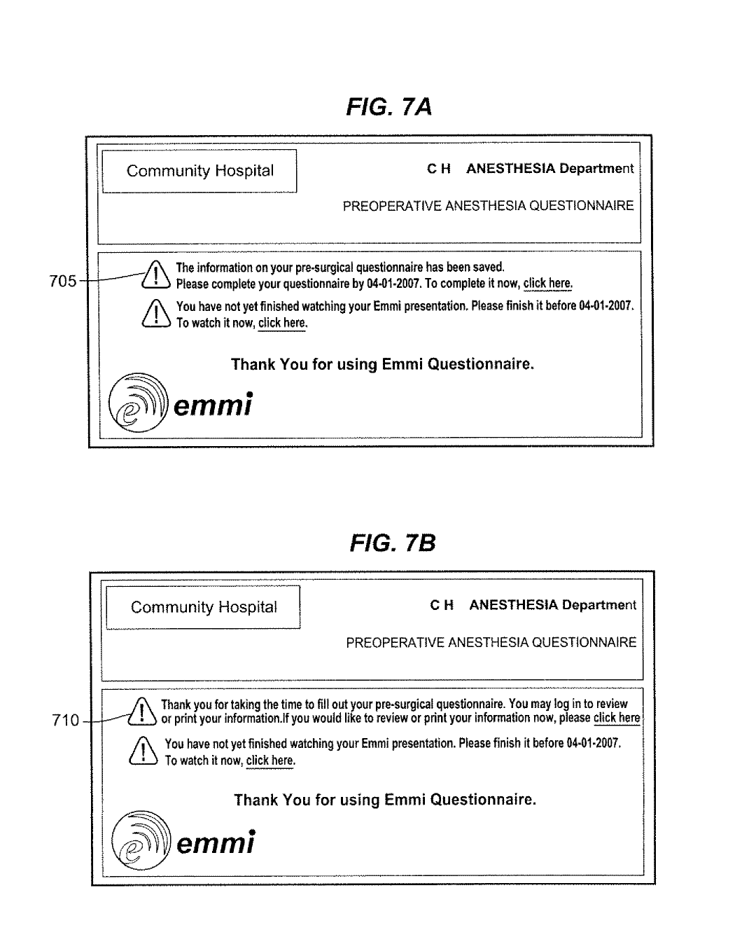

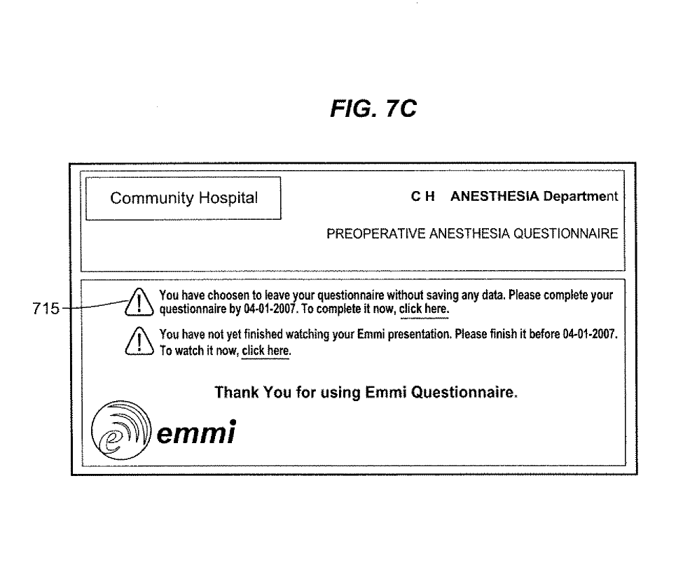

With reference to FIGS. 1, 3, 4, 6 and 7, at block 415, a patient 310 may select one of the status assignment buttons 640 to exit and/or save the questionnaire 605. Selecting the save and finish later button 645 may preserve the patient's 310 current answers in the questionnaire 605 while maintaining the ability to return to complete the questionnaire 605. The patient's 310 responses may be stored locally at the patient's 310 network computer 110, remotely at a facility server 120, or at any other suitable storage area. Upon selecting the save and finish later button 645, the patient 310 may be notified 705 that the entered information may be saved with the ability to return to complete the questionnaire 605. The finish button 650 may allow the patient 310 to submit a completed questionnaire 605 to the provider 305. The finish button 650 may also initiate a validation routine to verify the patient's 310 correct information or that the patient completed required portions 660 of the questionnaire 605. Upon selecting the finish button 650, the patient 310 may be notified 710 that the entered information may be saved with the ability to review or print the questionnaire 605. The exit button 655 may allow a patient 310 to exit the questionnaire 605 without preserving the currently-entered information while maintaining the ability to return to complete the questionnaire 605. Further, the patient 310 may be notified 715 that the entered information was not saved, but that the method 400 preserved the ability to return to complete the questionnaire 605.

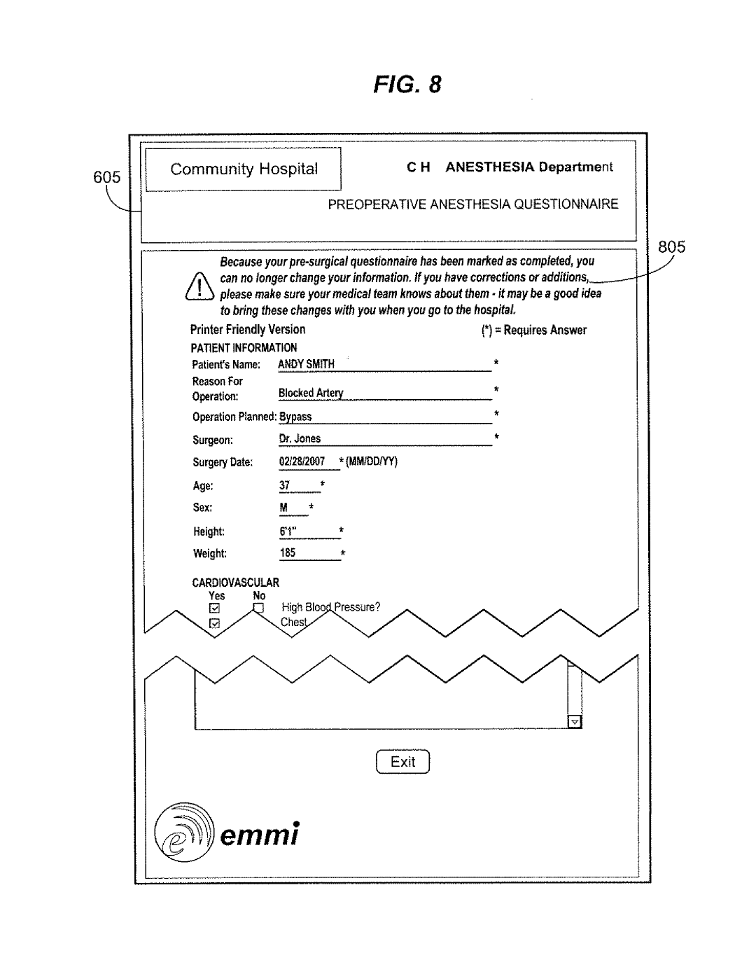

With reference to FIGS. 3, 4, 6, and 8, at block 420, the patient 310 may have completed the questionnaire 605 and, at block 425, attempt to modify the previously-submitted responses. In one embodiment, the patient 310 may select a finish button 650 of the questionnaire 605 and exit. After selecting the finish button 650, the patient 310 may realize that he entered an incorrect number for his body weight and attempt to correct the questionnaire 605. At block 430, the patient 310 may receive notice 805 that he may not modify the questionnaire 605. In a further embodiment, the patient 310 may receive notice 805 that he may no longer change any questionnaire 605 information along with a recommendation to bring any additions, modifications, or deletions to the attention of the patient's 310 medical team or provider 305. In other embodiments, the notice 805 may include contact information or other instructions that may allow the patient 310 to contact his provider 305 directly, send an e-mail, or otherwise ensure that the provider 305 is aware of the information change before the test, procedure, or other step in the patient's 310 course of treatment.

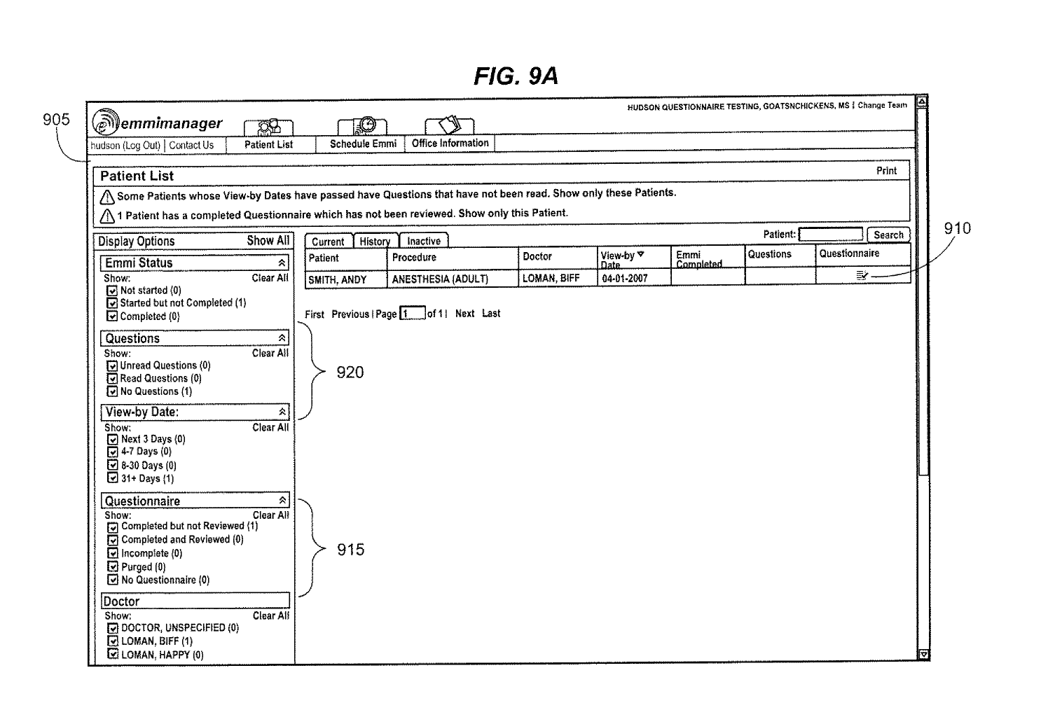

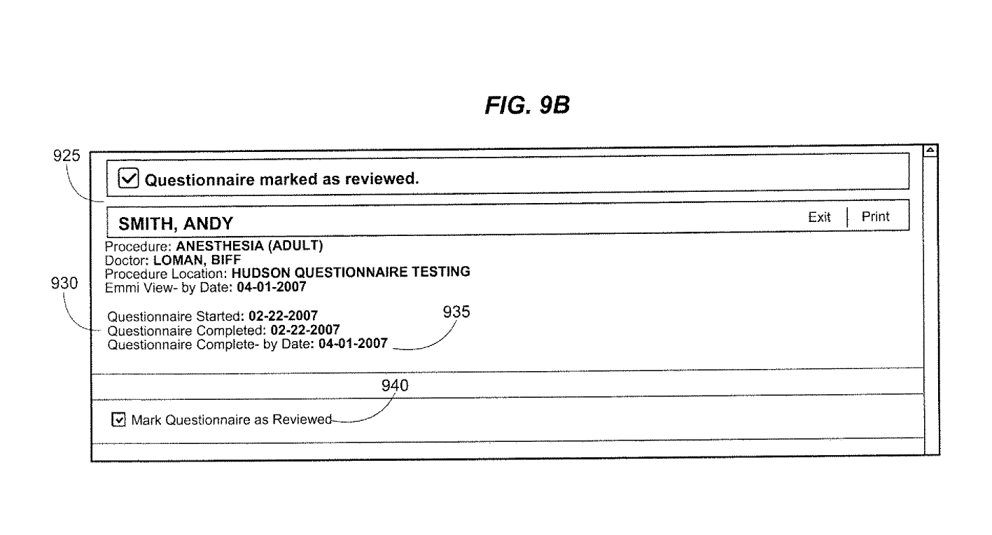

With reference to FIGS. 3, 4, 6, and 9, upon the patient's 310 completion of the questionnaire 605 and selection of a status assignment button 640, a provider 305 or other reviewing authority such as a nurse or qualified technician may view the questionnaire 605 data at a provider user interface 905. In one embodiment, the questionnaire 605 data that is viewed at the provider user interface 905 is accessed from a server 120 or other common storage area at the provider 305 or another source. Upon receipt, the provider user interface 905 may include a questionnaire indicator 910. In one embodiment, the questionnaire indicator 910 may include a visual indication of whether or not a reviewing authority at the provider 305 has reviewed the questionnaire 605. For example, a color of the questionnaire indicator 910 may designate a questionnaire status 915, for example, completed but not reviewed, completed and reviewed, incomplete, purged, or not received. In a further embodiment, the provider user interface 905 may include an indication to a provider 305 that a text field 635 of the questionnaire 605 includes a question from the patient 310 to the provider 305. The provider user interface 905 may also include detailed questionnaire information 925, including a completion date 930 and a Complete-by date 935. Of course, the provider user interface 905 may also include many other characteristics of the questionnaire 605. At block 435, the patient 310 may notify the provider 305 of any additional, corrected, or modified information to include with the questionnaire 605.

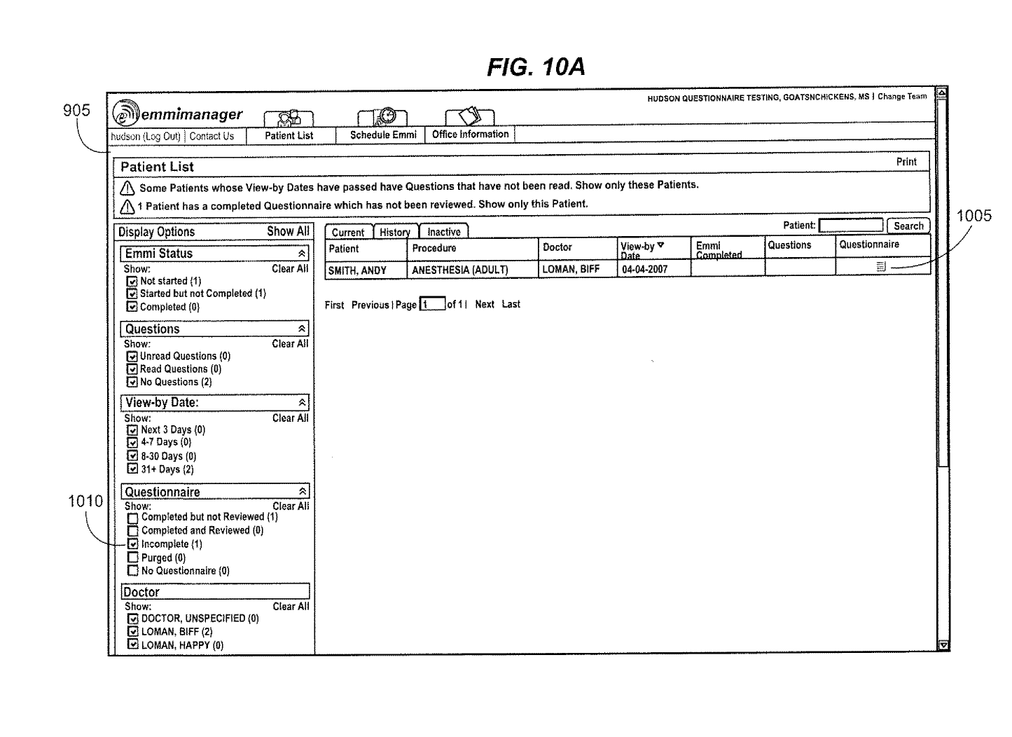

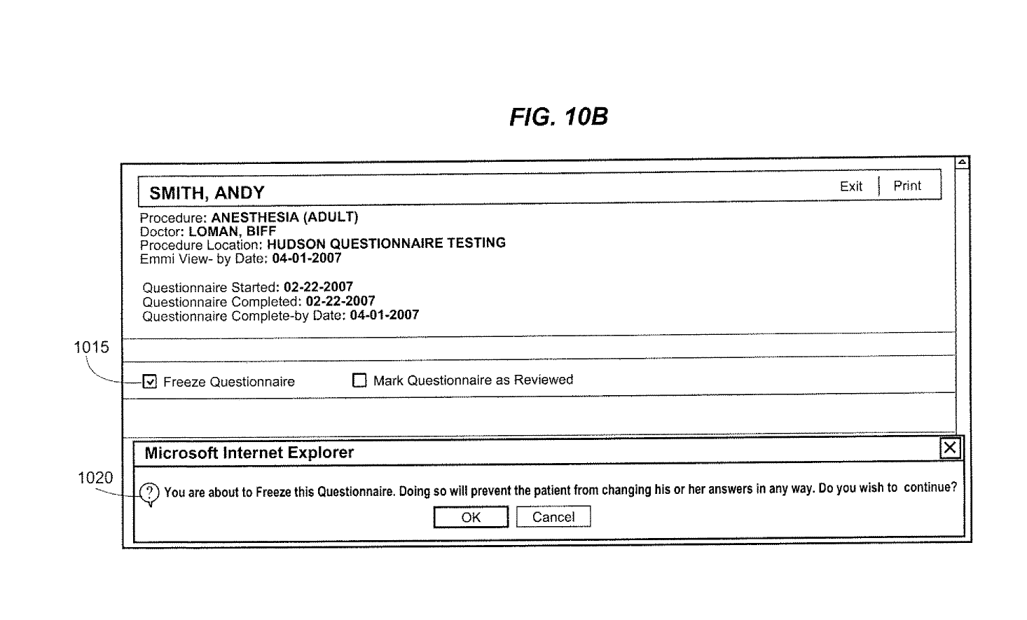

With reference to FIGS. 3, 4, 6, 9, and 10, at block 420, the patient 310 may not have completed the questionnaire 605, however, at block 440, a reviewer at the provider 305 may have received and subsequently frozen the questionnaire 605 before the patient 310 could make any changes. In one embodiment, the provider user interface 905 may display a questionnaire 1005 with a status of incomplete 1010. Upon selection by the provider 305, another interface may display detail about the incomplete questionnaire 1005, allowing the provider 305 to view the previously-submitted information and “freeze” 1015 the ability of the patient 310 to change the current responses. The provider 305 may also be given a warning 1020 to communicate the consequences of freezing the document to the patient 310. In a further embodiment, at least one of freezing the questionnaire 605 by the provider 305, the patient 310 completing and saving the questionnaire 605 by activating the Finish button 650, or the expiration of a Complete-by Date 935 may prevent a patient 310 from communicating any additional information to the provider 305 through the questionnaire 605.

If, at block 440, the provider 305 froze the questionnaire 605, then at block 445, when the patient 310 returns to the questionnaire 605 and attempts to correct or complete it, at block 430, the user may receive a notice 805 indicating the inability to use the questionnaire 605 to communicate any farther actionable information to the provider 305. A healthcare questionnaire 605 may be frozen by a number of manual or automatic methods. In one embodiment, a provider 305 may freeze a questionnaire 605 in response to any action that may allow or prompt a patient 310 to submit information under the mistaken belief that the provider 305 may take action in response to such information. In another embodiment, the questionnaire 605 may be frozen after the patient 310 submits a response upon which the provider 305 may take action. For example, the questionnaire 605 may be frozen upon completion of a number or percentage of the required fields 660 of the questionnaire 605. Also a patient 310 may contact a provider 305 to express concerns that are not adequately addressed by the questionnaire 605 or may otherwise provide information that is not addressed by the questionnaire 605 to prompt a freeze action by the provider 305. Likewise, a receipt of test results or other information not addressed by or included within the questionnaire 605 may result in a freeze action by the provider 305.

Other embodiments may include a provider review function 940 whereby a provider 305 may administratively mark a patient's 310 responses to the questionnaire 605. The reviewed function 940 may allow the provider 305 to record a patient's 310 questionnaire 605 responses as complete and ready for action or implementation within the patient's 310 course of treatment. In one embodiment, the provider 305 may be able activate a reviewed function 940 after a patient 310 may no longer submit actionable information through the questionnaire 605. As previously discussed, a patient 310 may no longer be able to submit actionable information to the provider 305 upon the occurrence of at least one of freezing the questionnaire 605 by the provider 305, the patient 310 completing and saving the questionnaire 605 by activating the Finish button 650, or the expiration of a Complete-by Date 935. Additionally, a provider 305 may be able to take an action that may remove a previous frozen, reviewed, or expired designation from a questionnaire 605. For example, functions may allow a provider 305 to extend a Complete-by date 935, reverse a reviewed function 940, or unfreeze the questionnaire 605 to thereby allow a patient 310 to continue to respond to a previous questionnaire 605 or respond to a modified questionnaire 605. Of course, other criteria may be automatically or manually evaluated to determine whether or not the patient 310 may be prevented from entering, modifying, or editing any further information related to a questionnaire 605.

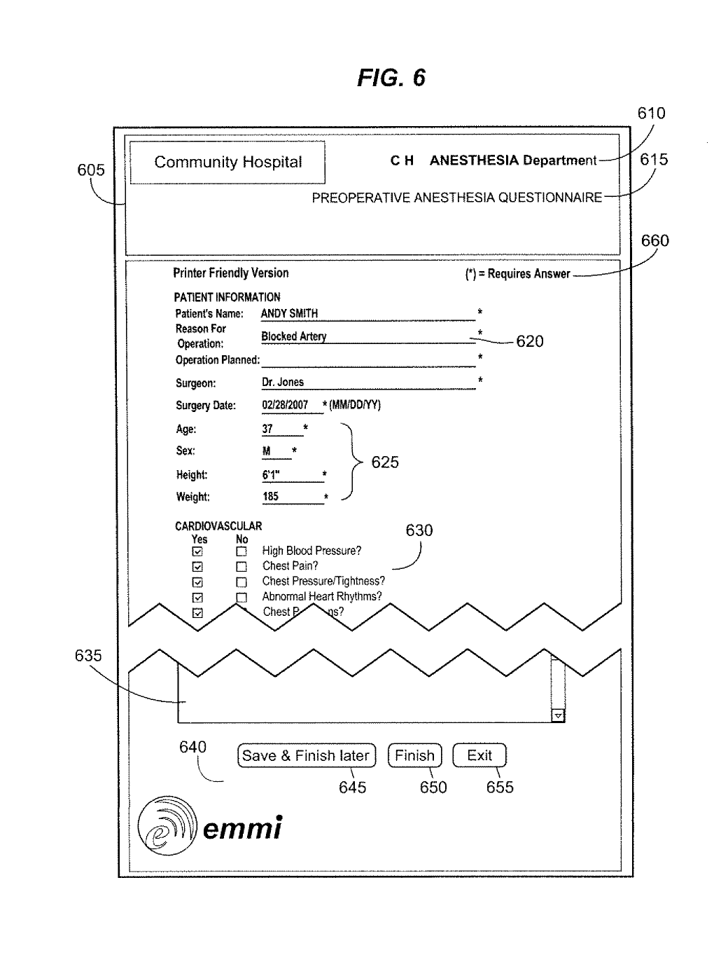

The reviewed function 940 may also incorporate the patient's 310 responses into an electronic patient 310 health record. In one embodiment, the electronic patient health record is a singleton that may only be instantiated once. For example, a single instance of the electronic health record may ensure that modifications to the record may only originate from one source at a time. The patient 310 responses may modify existing electronic health record information or may incorporate new information. For example, with reference to FIG. 6, the patient's 310 response to the general physical characteristics 625 may be incorporated into an electronic patent health record or may modify previous information within the record.

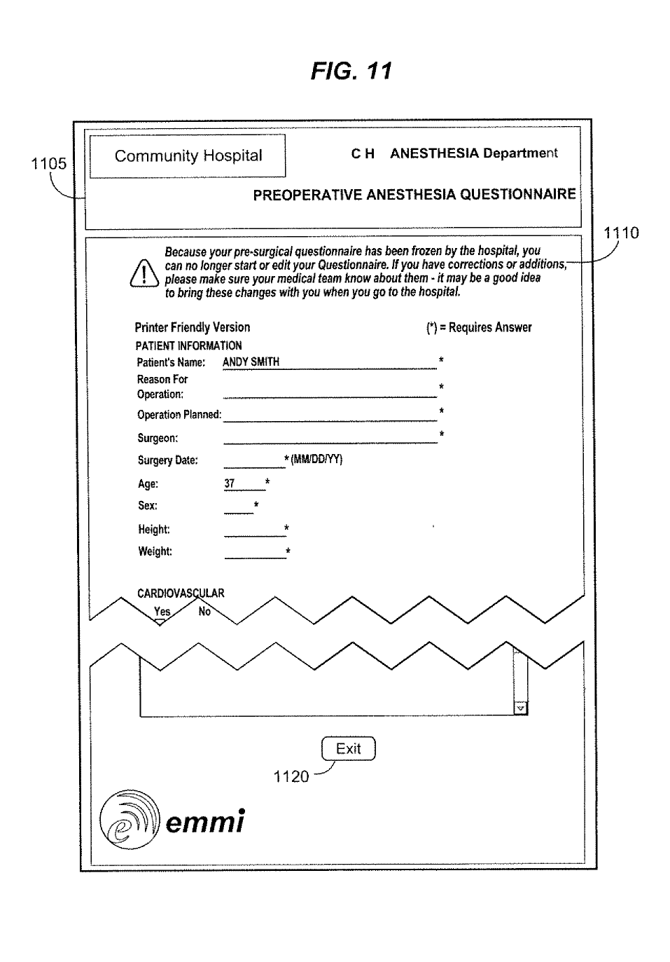

With reference to FIG. 11, in one embodiment, when a patient 310 attempts to return to a frozen questionnaire 1105, a notice 1110 may indicate that the patient 310 may no longer edit the document. In a further embodiment, at a frozen questionnaire 1105, the patient 310 may review, print, or exit the questionnaire 1105. If, however, at block 440, the provider 305 has not frozen the questionnaire 605, then the patient 310 may return to the document to continue adding information or otherwise communicate with the provider 305.

Thus, healthcare questionnaires may offer timely and accurate patient 310 information to healthcare providers. However, during a patient's 310 course of treatment, a patient's 310 changes to a questionnaire 605 may go unnoticed by a provider 305. A patient 310 may be under the assumption that the provider 305 will receive the information before a critical time. To avoid miscommunication, the provider 305 may freeze the questionnaire 605 so that the patient 310 may be prohibited from editing previously-provided information or otherwise submitting actionable information to the provider 305. As described above, allowing the provider 305 to freeze the patient's 310 responses, the patient 310 may submit the questionnaire 605 either knowing that the provider 305 will receive the information in a timely fashion or that the patient 310 must provide the information through another channel.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

What is claimed is:

1. A method for ensuring that a provider is able to take an action toward a patient in response to medical information provided by the patient through an electronic medical questionnaire, the method comprising:
delivering the electronic medical questionnaire to the patient, the electronic medical questionnaire including a question regarding the action and a complete-by date;
delivering a first medical information from the patient to the provider via the electronic medical questionnaire, wherein the first medical information is a first response to the question regarding the action;
preventing delivery of a second medical information from the patient to the provider via the electronic medical questionnaire upon an occurrence of at least one of:
the provider reviewing the first medical information,
the patient providing the second medical information after an expiration of the complete-by date, or
the patient submitting a completed electronic medical questionnaire to the provider before the expiration of the complete-by date,
wherein the second medical information is at least one of a second response to the question regarding the action or a modification of the first medical information; and
notifying the patient that the second medical information is undeliverable via the electronic medical questionnaire.

2. The method of claim 1, wherein delivering the electronic medical questionnaire to the patient comprises providing the electronic medical questionnaire to the patient over at least one of a public Internet, a private intranet, and a cellular network.

3. The method of claim 1, further comprising modifying an electronic health record with the first response, wherein the electronic health record only includes the medical information associated with the patient.

4. The method of claim 3, further comprising restricting access to the electronic health record after modifying the electronic health record with the first response.

5. The method of claim 1, further comprising maintaining a single electronic copy of each electronic medical questionnaire associated with the patient.

6. The method of claim 1, wherein the medical information comprises patient responses to the electronic medical questionnaire informed consent information bodily characteristics, medical test results, medical examination reports, prescription drug information, family medical history information, and patient demographic information.

7. The method of claim 6, wherein the patient questionnaire responses comprise patient information related to pre-surgery, post-surgery, informed consent, administration, medical testing, symptoms, demographics, and physical characteristics.

8. The method of claim 1, wherein the provider comprises at least one of a surgeon, a general medical practitioner, a nurse, a case manager, a healthcare insurance company, and a pharmacy benefits manager.

9. The method of claim 1, further comprising entering patient medical information into one of a plurality of electronic health records.

10. The method of claim 9, wherein entering patient medical information into one of the plurality of electronic health records comprises partially completing the electronic medical questionnaire.

11. A method for freezing a response given by a patient to at least one of a plurality of questions directed to the patient from a healthcare provider:
accessing a healthcare questionnaire, the healthcare questionnaire including the plurality of questions directed to the patient from the healthcare provider;
submitting the response given by the patient to at least one of the plurality of questions, the response including information that is actionable by the healthcare provider and related to at least one of a medical test, a surgical procedure, and a medical course of treatment event;
assigning a frozen status to the healthcare questionnaire upon the provider reviewing the first medical information, the frozen status preventing modification of the previously-submitted response; and
communicating a notice to the patient, the notice including the frozen status and indicating that the response is unchangeable by the patient;
wherein the response is actionable if it is communicated to the healthcare provider within a period of time before the medical test, the surgical procedure, or the medical course of treatment event.

12. The method of claim 11, further comprising the healthcare provider freezing the healthcare questionnaire as a result of the response indicating that the patient mistakenly believes that the response is actionable by the healthcare provider.

13. The method of claim 11, further comprising assigning the frozen status after a number of submitted responses is above a threshold percentage of a total number of the plurality of questions.

14. The method of claim 11, wherein the medical course of treatment event includes at least one of a receipt of results of the medical test, an appointment between the patient and the healthcare provider, a change in a diagnosis of the patient, a receipt of information not in reply to one of the plurality of questions, or a question posed by the patient to the healthcare provider indicating an issue not addressed by the healthcare questionnaire.

15. The method of claim 11, wherein assigning the frozen status to the healthcare questionnaire includes the healthcare provider assigning a reviewed designation to the response, the patient completing and saving the healthcare questionnaire by activating a finish button, or expiration of a complete-by date.

16. The method of claim 15, further comprising the healthcare provider removing the frozen status from the healthcare questionnaire by reversing the reviewed designation, extending the complete-by date, unfreezing the healthcare questionnaire, or modifying the healthcare questionnaire.

17. The method of claim 11, wherein the notice includes contact information for the healthcare provider.

18. A computing system including a memory and a processor physically configured to execute computer executable code for:
delivering an electronic medical questionnaire from a healthcare provider to a patient, the electronic medical questionnaire including at least one question;
communicating a first response to the at least one question from the patient to the healthcare provider through the electronic medical questionnaire, the first response including information upon which the healthcare provider implements an action regarding a course of treatment associated with the patient;
attempting to communicate a second response to the at least one question from the patient to the healthcare provider through the electronic medical questionnaire; and
preventing communication of the second response to the at least one question from the patient to the healthcare provider through the electronic medical questionnaire, wherein the second response includes information upon which the healthcare provider is able to implement the action regarding the course of treatment associated with the patient after a critical time during the course of treatment.

19. The computing system of claim 18, further comprising the critical time exceeding a period of time before an event during the course of treatment associated with the patient.

20. The computing system of claim 19, wherein the event during the course of treatment associated with the patient includes a medical test or a surgical procedure.
